(19) United States
(12) Patent Application Publication
(10) Pub. No.: US 2011/0133886 A1
(43) Pub. Date: Jun. 9, 2011

(54) MOBILE IDENTIFICATION TRANSMITTER IN A SAFETY SYSTEM

(75) Inventors: Stefan Mönig, Schwelm (DE); Helmut Schumacher, Coesfeld (DE); Jörg Simon, Wulfrath (DE); Veith Schröter, Essen (DE)

(73) Assignee: Huf Hulsbeck & Furst GmbH & Co. KG, Velbert, DE (US)

(21) Appl. No.: 12/996,573

(22) PCT Filed: May 29, 2009
(86) PCT No.: PCT/EP09/56654

§ 371 Date: Feb. 10, 2011

(30) Foreign Application Priority Data
Jun. 4, 2008 (DE) 10 2008 026 676.0

(51) Int. Cl. G06F 7/04

(52) U.S. Cl. 340/5.61

(57) ABSTRACT

The invention relates to a mobile identification transmitter (10) in a safety system for a keyless activation of a locking apparatus (43) of a motor vehicle (40), with a housing (11) in which an electronic unit (12) with at least one transmitting and receiving unit (13) is arranged, which electronic unit (12) communicates with a communication unit (41) in the motor vehicle, by means of which an identification check for determining a user authorization can be performed. The invention provides that vehicle data from the motor vehicle (40) can be transmitted to the electronic unit (12), and that the electronic unit (12) comprises a connection means (20) for transmitting the vehicle data to an external data device (30).

The invention relates to a mobile identification transmitter in a safety system for a keyless activation of a locking apparatus of a motor vehicle in accordance with the preamble of Claim 1, with a housing in which an electronic unit with at least one transmitting and receiving unit is arranged, which electronic unit communicates with a communication unit in the motor vehicle, by means of which an identification check for determining a user authorization can be performed. Furthermore, the invention relates to a monitoring system for a motor vehicle in accordance with independent Claim 10 as well as to a process for controlling a monitoring system for a motor vehicle according to Claim 18.

Mobile identification transmitters are used in numerous applications in motor vehicles for increasing user comfort. Traditionally, infrared systems or radio systems are used in which the authorized user actively actuates the identification transmitter in order to transmit a signal to an electronic unit provided in the motor vehicle for opening the vehicle. These systems are also designated as active keyless entry systems.

Even electronic safety systems for closing devices of motor vehicle are rapidly penetrating the market that, in addition to the described functionality dependent on a control, are additionally equipped with a functionality independent of a control, the so-called “passive keyless entry” or “keyless-go” functionality. In contrast to the conventional remote control, in the “passive keyless-entry functionality” no active control of the mobile identification transmitter is necessary for locking and unlocking (securing and releasing) the locking apparatus or for actuating the immobilizer. For example, during the activation of the door handle of the motor vehicle a communication between the motor vehicle and an identification transmitter is started and upon a positive identification check (authentication) the electrical unlocking of the locking apparatus is activated.

Modern motor vehicles frequently have sensors that measure the current states and adjustments of the motor vehicle. Thus, it is known that the tire pressure in motor vehicles is permanently checked by an appropriately designed monitoring system. If there is a drop in the tire pressure below a critical value the vehicle owner can be informed about this. Likewise, even information about running performance, service intervals and/or other information important for the operation of the motor vehicle can be stored and/or evaluated in a central computer system of a modern motor vehicle. It turned out that this has the disadvantage that this information is not available to the vehicle owner. It is possible to have the information displayed and then noted on a display inside the vehicle. However, this proved to be very susceptible to errors and complicated. In particular, when managing a fleet of vehicles an individual noting of vehicle data significant for operation is not possible.

The object of the present invention is to provide a mobile identification transmitter, which overcomes the above disadvantages, in particular to provide a mobile identification device, which allows monitoring of key vehicle data.

This problem is solved in an advantageous manner by a mobile identification transmitter in a safety system for a keyless activation of a locking apparatus of a motor vehicle with the features of Claim 1. In addition, the problem is solved in an advantageous manner by a monitoring system for a motor vehicle with the features of Claim 10. Additionally, the problem is solved in an advantageous manner by a process for controlling a monitoring system for a motor vehicle with the features of Claim 18. Further advantageous embodiments of the present apparatuses result from the particular dependent claims. Features and details described in conjunction with the mobile identification transmitter in accordance with the invention also apply, of course, in combination with the monitoring system in accordance with the invention and with the process in accordance with the invention as well as inversely. The features mentioned in the claims and in the specification can be significant for the invention individually or in any combination.

It is provided in the mobile identification transmitter that vehicle data can be transmitted from the motor vehicle to the electronic unit in order to transmit the vehicle data to an external data device.

The core of the invention resides in the fact that it is possible for the mobile identification transmitter to receive vehicle data from the motor vehicle. This vehicle data can then be transmitted to an external data device. A vehicle owner therefore has the possibility of reading out the vehicle data present in the vehicle and storing it on the mobile identification transmitter. The vehicle data can be subsequently transmitted by the vehicle owner to the external data device. As will be explained in the following, it also proved to be advantageous if the external data device is arranged in an area in which the vehicle owner frequently stops such as, for example, his dwelling. According to the invention the external data device is used to read out the vehicle data from the mobile identification transmitter and evaluate it. Thus, the vehicle owner has the possibility of monitoring the vehicle data of his motor vehicle indirectly or directly by the external data device. Modern electronics make possible a visual display of the vehicle data in order to indicate any boundary limits and/or service intervals. Consequently, the mobile identification transmitter in combination with the external data device makes possible a display of the vehicle data that is significant for operation to the vehicle owner. Furthermore, a forwarding of the vehicle data, for example, to a workshop is conceivable. There, further analyses of the vehicle data can be carried out that serve to inform the vehicle owner, if necessary, about upcoming inspections. Also, parts subject to wear can be ordered in advance by integrating the mobile identification transmitter of the invention and/or the monitoring system of the invention into a fleet management with a plurality of vehicles so that these parts can be integrated in a timely manner into the motor vehicles without the occurrence of large downtimes.

An advantageous embodiment of the invention provides that at least one transmitting and receiving unit of the electronic unit and/or the connection means have at least one of the following technologies: wireless LAN (IEEE 802.11), FireWire (IEEE 1394), USB (Universal Serial Bus), wireless USB, HDMI (High-Definition Multimedia Interface), IrDA (Infrared Data Association), Bluetooth, Unilink, ATA/ATAPI (Advanced Technology Attachment with Packet Interface), IEEE 488, IEEE 1284, bidirectional radio path, Near Field Communication (NFC) or inductive transmission.

Another advantageous embodiment provides that the mobile identification transmitter comprises a display, in particular that the display uses at least one of the following means: a light-emitting diode (LEDs), an organic light-emitting diode (OLEDs), a liquid crystal display (LCDs), a surface-conduction electron emitter display (SED) or a field emission display (FED).

Another measure that improves the invention provides that the vehicle data can be displayed on the display.

A possible embodiment of the invention provides that the transmitting and receiving unit secures the communication with the communication unit in the motor vehicle and receives the vehicle data from the motor vehicle, in particular that the connection means is part of the transmitting and receiving unit or makes use of the transmitting and receiving unit. The electronic unit serves to control the identification transmitter. A communication with the communication unit in the vehicle is built up via the electronic unit. A transmission of codes, etc, takes place via this communication in order to be able to carry out an identification check in order to determine the authorization of the user. Information is transmitted in the framework of this unidirectional and/or bidirectional communication that makes possible an authentication of the identification transmitter. In order to establish this communication a transmitting and receiving unit is arranged in the electronic unit. Electromagnetic waves are transmitted to the communication unit of the motor vehicle by the transmitting and receiving unit. According to the invention a connection means is provided for transmitting the vehicle data to the external data device. Even this connection means is integrated in the electronic unit. In order to carry out the transmission of the vehicle data to the external data device it is possible to use electromagnetic waves. Consequently, the connection means can utilize the transmitting and receiving unit of the electronic unit that is also used in the framework of the identification check. Thus, the connection means makes use of the transmitting and receiving unit that is used by the electronic unit in order to make possible the authentication vis-à-vis the motor vehicle. Depending on its design, the transmitting and receiving unit can radiate electromagnetic waves with different wavelengths as a function of whether it is communicating with the communication unit in the vehicle or with the external data device. Alternatively, it is also conceivable that several transmitting and receiving units are arranged in the housing. One of the transmitting and receiving units serves here for communication in the vehicle and another, separate transmitting and receiving unit for transmitting the vehicle data to the external data device. The first alternative has the advantage that a smaller number of components are used. In contrast thereto, the second alternative is distinguished in that different types of communication can be readily formed.

An advantageous variant of the invention provides that the mobile identification transmitter comprises a data memory and/or an energy storage device, in particular a rechargeable energy storage device.

Another advantageous embodiment provides that a computer program can be transmitted to the mobile identification transmitter by the connection means.

A possible embodiment of the invention provides that the mobile identification transmitter comprises a computer element for controlling the electronic unit and/or for evaluating the vehicle data.

Another measure that improves the invention provides that the transmitting and receiving unit is a part of an existing active keyless entry system and/or of a passive keyless entry system.

The object of the invention is also solved by a monitoring system for a motor vehicle, with a mobile identification transmitter and an external data device, in which the mobile identification transmitter is a part of a safety system for a keyless activation of a locking apparatus of the motor vehicle, the mobile identification transmitter has a housing in which an electronic unit with at least one transmitting and receiving unit is arranged, the electronic unit communicates with a communication unit in the motor vehicle, by means of which communication unit an identification check can be made to determine a user authorization, vehicle data can be transmitted from the vehicle to the electronic unit, and the electronic unit comprises a connection means for transmitting the vehicle data to the external data device. Preferred embodiments of the monitoring system in accordance with the invention for a motor vehicle are cited in the dependent claims. Details and features of the mobile identification transmitter are also valid for the monitoring system in accordance with the invention and vice versa.

The monitoring system in accordance with the invention contains the mobile identification transmitter as well as the external data device. The core of the monitoring system in accordance with the invention is such that it makes it possible for a vehicle owner of a motor vehicle to transmit vehicle data from the motor vehicle to the external data device by means of the mobile identification transmitter. The mobile identification transmitter consequently serves as a type of intermediate memory. The vehicle data from the motor vehicle is stored in the mobile identification transmitter and subsequently transmitted to the external data device, which is not connected to the motor vehicle.

An advantageous variant of the monitoring system of the invention provides that a data connection to the Internet can be built up by the external data device. The vehicle data can be transmitted to a service system of a vehicle manufacturer and/or of a workshop via the data connection to the Internet. The vehicle data can then be subjected to further analysis there. In particular it is possible, following the analysis of the vehicle manufacturer and/or of the workshop, to send information via the Internet to the external data device and/or to an e-mail address of the vehicle owner and inform him about the state of the vehicle. Thus, in particular information relative to safety such as, e.g., the state of the brakes, can be communicated directly to the vehicle owner. Furthermore, the workshop can make preparations for ensuring a replacement of parts subject to wear. The data connection of the external data device to the Internet can consist on the one hand in that the external data device has its own interface such as a modem. However, it is also conceivable that the external data device is connected to a PC that is used as a bridge for producing the data connection to the Internet.

Another advantageous embodiment of the monitoring system of the invention provides that the external data device evaluates the vehicle data. An evaluation of the vehicle data on the external data device would have the advantage that information relevant to safety such as the tire pressure could be checked immediately.

A possible embodiment of the monitoring system of the invention provides that the external data device visualizes the vehicle data and/or the evaluated vehicle data. The visualizing of the vehicle data and/or of the evaluated vehicle data further increases the safety since a vehicle owner can be directly referred to any safety-relevant information.

A further measure that improves the invention provides that the external data device is at least one of the following devices: a PC, a PDA, a fax, a notebook or a mobile telephone.

A further embodiment of the monitoring system of the invention provides that the external data device comprises a receiver for the mobile identification transmitter, in particular, that the external data device comprises a charging device for a rechargeable energy storage device of the mobile identification transmitter.

A further embodiment of the monitoring system of the invention provides that the external data device comprises an interface for communicating with the connection means of the mobile identification transmitter.

An embodiment of the monitoring system of the invention provides that the interface has at least one of the following technologies: wireless LAN (IEEE 802.11), FireWire (IEEE 1394), USB (Universal Serial Bus), wireless USB, HDMI (High-Definition Multimedia Interface), IrDA (Infrared Data Association), Bluetooth, Unilink, ATA/ATAPI (Advanced Technology Attachment with Packet Interface), IEEE 488, IEEE 1284, bidirectional radio path, Near Field Communication (NFC) or inductive transmission.

Furthermore, the above-cited problem is also solved by a process for controlling a monitoring system for a motor vehicle, in which the monitoring system comprises a mobile identification transmitter and an external data device, the mobile identification transmitter is part of a safety system for a keyless activation of a locking apparatus of the motor vehicle, which process comprises the steps:
transmission of vehicle data to the electronic unit,
transmission of the vehicle data from the electronic unit to the external data device, and
evaluation of the vehicle data by the external data device.

Features and details cited in connection with the process in accordance with the invention naturally also apply to the mobile identification transmitter and to the monitoring system as well as vice versa. Other advantageous embodiment of the process of the invention can be gathered from the dependent claims.

Another measure that improves the process provides that the external data device transmits the vehicle data to the Internet.

A further variant of the process of the invention provides that the mobile identification transmitter is placed spatially in the vicinity of the external data device in order to initiate the transmission. Through appropriate design the identification transmitter can determine whether it is in close proximity to the external data device. Only then can a transmission of the vehicle data to the external data device be initiated. Thus, for example, the external data device can be arranged in a home of a vehicle owner or in a vehicle central of a company operating a vehicle fleet. This variant of the process ensures that the vehicle data can only be transmitted from the identification transmitter if the external data device is also ready to receive the vehicle data. This excludes unnecessary transmission of the vehicle data by the mobile identification transmitter.

Another advantageous embodiment provides that the vehicle data is transmitted to the mobile identification transmitter if the latter is arranged inside the motor vehicle.

According to the invention it proved to be advantageous if the monitoring system is operated according to one of the above-described processes. In addition, it is advantageous if the monitoring system uses a mobile identification transmitter designed according to at least one of the described claims.

The above-cited problem is also solved by a computer program product for carrying out the process according to one or more of the described process claims. It is provided in this instance in accordance with the invention that the process steps are integrated in a program stored in the computer program product when the method is carried out on the data processing unit.

Further advantages, and features and details of the invention result from the following description in which exemplary examples of the invention are described in detail with reference made to the drawings. The features mentioned in the claims and in the specification can be significant for the invention individually or in any combination.

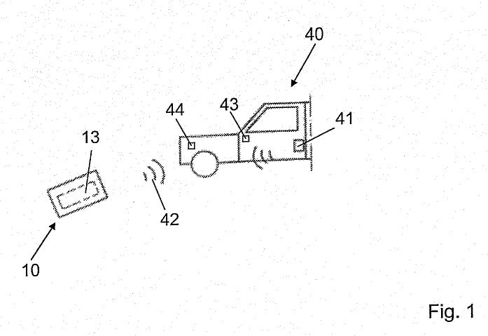

FIG. 1 shows a schematic view of the safety system in accordance with the invention with a mobile identification transmitter and a locking device for a motor vehicle,

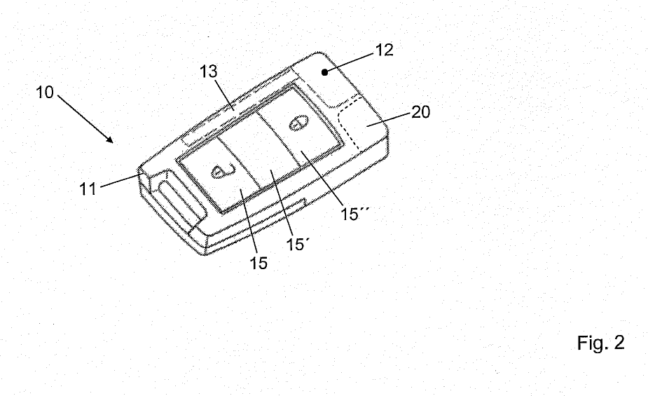

FIG. 2 shows the mobile identification transmitter in accordance with the invention and

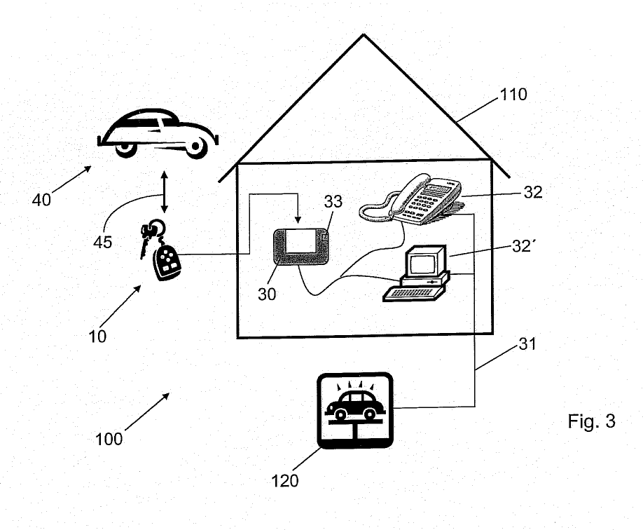

FIG. 3 shows a monitoring system designed in accordance with the invention.

FIG. 1 shows a mobile identification transmitter 10 of a safety system for a keyless activation of a locking device 43 of a motor vehicle 40. Identification transmitter 10 is designed with a housing 11 in which an electronic unit 12 with a transmitting and receiving unit 13 is arranged. Mobile identification transmitter 10 can establish a communication 42 with a communication unit 41 in a vehicle via transmitting and receiving unit 13. Information is exchanged thereby by means of communication 42 that serves to authorize mobile identification transmitter 10. In particular, codes and/or keys can be transmitted unidirectionally or bidirectionally in the framework of communication 42. The goal is that the motor vehicle checks the authorization of mobile identification transmitter 10. As soon as it is determined that mobile identification transmitter 10 is authorized to initiate a locking or unlocking of the motor vehicle, an appropriate signal is transmitted to locking apparatus 43 to order to initiate an opening or closing of motor vehicle 40 with it.

Known motor vehicles 40 comprise sensor elements 44 that monitor elements of motor vehicle 40 that are essential for its operation. Thus, for example, the state of the brakes can be monitored by an appropriately designed sensor element 44. The vehicle data collected can be collected by a central information system of motor vehicle 40. The invention provides that the vehicle data from motor vehicle 40 is transmitted to electronic unit 12 of mobile identification transmitter 10. Mobile identification transmitter 10 thus serves as a memory unit for the vehicle data. The transmission can take place via transmitting and receiving unit 13. Consequently communication 42 is used not only for authorization but also for transmitting the vehicle data. It is alternatively conceivable that another transmitting and receiving unit is arranged in electronic unit 12 which transmitting and receiving unit is provided exclusively for receiving and transmitting the vehicle data from motor vehicle 40 to mobile identification transmitter 10 and optionally also in the opposite direction.

FIG. 2 shows mobile identification transmitter 10 designed in accordance with the invention. Mobile identification transmitter 10 has a housing 11. An electronic unit 12 is integrated inside housing 11. Electronic unit 12 serves to monitor the functions controlled with mobile identification transmitter 10. In order to ensure this, it proved to be advantageous if mobile identification transmitter 10 has a data memory. This data memory can be integrated in electronic unit 12. In order to ensure a supply of energy, mobile identification transmitter 10 also comprises an energy storage device. It proved to be advantageous if this device is a rechargeable energy storage device. Furthermore, a computer element is integrated in electronic unit 12. A computer program can run on the computer element in order to make the operation of mobile identification transmitter 10 possible. The computer element can preferably be an FPGA (Field Programmable Gate Array), a microcontroller or integrated circuit designed in some other way.

As FIG. 2 clarifies, a part of electronic unit 12 is transmitting and receiving unit 13. It serves to establish communication 42 with vehicle 40. In the exemplary embodiment shown transmitting and receiving unit 13 is arranged on one of the side surfaces of housing 11. In order to overcome the above-cited disadvantages electronic unit 12 comprises a connection means 20, which is also arranged in housing 11 of mobile identification transmitter 10. Connection means 20 makes it possible to transmit vehicle data of motor vehicle 40 to an external data device 30.

In order to make this transmission possible, connection means 20 can have its own transmitting and receiving unit 13. Alternatively, it is also possible that connection means 20 uses transmitting and receiving unit 13 of electronic unit 12. Thus, at least one transmitting and receiving unit 13 is required to make possible a communication 42 between the vehicle and external data device 30. The vehicle data emitted from motor vehicle 40 is intermediately stored in electronic unit 12. The above-described data memory is used for this. Connection means 20 transmits the vehicle data to external data device 30 as a function of an external parameter or upon the desire of the user. In order to initiate this transmission it proved to be advantageous if mobile identification transmitter 10 comprises an appropriately designed activating element. In the exemplary embodiment shown three activation elements 15, 15′, 15″ are integrated into housing 11 of mobile identification transmitter 10. Activation elements 15, 15″ serve to initiate a keyless activation of locking apparatus 43 of motor vehicle 40. Appropriately designed pictograms serve to illustrate the operation. An unlocking of locking apparatus 43 can be initiated on activation element 15. An appropriate command is generated by electronic unit 12 and transmitted to motor vehicle 40 via transmitting and receiving unit 13. If, on the contrary, a user wants to lock motor vehicle 40, an activation of activation element 15″ is sufficient. If the user is spatially close to external data device 30, a transmission of the vehicle data is initiated by an activation of activation element 15′. In addition, a display can also be integrated in housing 11 of mobile identification transmitter 10. This is not sketched in the exemplary embodiment shown in FIG. 2. The display can visually serve to represent vehicle data that was transmitted to mobile identification transmitter 10. It proved to be advantageous if the display is a liquid crystal display and/or a plasma screen.

FIG. 3 shows a monitoring system 100 in accordance with the invention. Monitoring system 100 serves to monitor motor vehicle 40. To this end vehicle data essential for operation is transmitted from motor vehicle 40 to described mobile identification transmitter 10. This transmission can take place in the framework of bidirectional communication 42. Alternatively, a transmission via a connection 45 is also conceivable that is not established by transmitting and receiving unit 13. Thus, for example, in the case of an integration of mobile identification transmitter 10 into a key receptacle of motor vehicle 40 a contact-loaded interface can be activated via which the vehicle data is transmitted from vehicle 40 to mobile identification transmitter 10. Alternatively, a Bluetooth interface can also be integrated into motor vehicle 40 that transmits the vehicle data to a correspondingly designed counter-interface of mobile identification transmitter 10. Another part of monitoring system 100 is the external data device 30. External data device 30 serves to read out and/or to receive the vehicle data from mobile identification transmitter 10. For example, external data device 30 can be constructed as a receptacle in which computer means 33 is integrated. A unidirectional and/or bidirectional connection between mobile identification transmitter 10 and external data device 30 takes place via an appropriately designed interface. The connection makes possible the transmission of vehicle data from mobile identification transmitter 10 to external data device 30. Depending on the design, external data device 30 can carry out an evaluation of the vehicle data with computer means 33. However, it is also conceivable that external data device 30 is connected to an evaluation element 32. Very different systems can be involved here. In FIG. 3 a telephone is shown on the one hand as evaluation means 32. Consequently, evaluation means 32 does not carry out an evaluation of the vehicle data itself but rather evaluation means 32 makes possible an access to a contact line 31 via which the vehicle data can be transmitted to a central unit where a unified evaluation then takes place. Alternatively, the evaluation means can also be a computer. In FIG. 3 evaluation means 32′ is additionally sketched in, which is a PC. An appropriately designed computer program can run on this PC that evaluates the vehicle data transmitted from external data device 30 and shows it visually on a monitor for the user of motor vehicle 40.

Evaluation means 32, 32′ are advantageously set up in a home 110 of the vehicle owner. The same applies to external data device 30. If the vehicle owner comes home, it is possible for him to introduce mobile identification transmitter 10 into the receptacle of external data device 30, which initiates a connection between external identification transmitter 10 and external data device 30. The vehicle data of motor vehicle 40 is transmitted to external data device 30 via this connection. A pre-evaluation of particularly safety-relevant information in the vehicle data can then take place. Thus, for example, brake wear and/or air pressure of the tires can be determined and compared with appropriate boundary values. To this end computer means 33 can access the corresponding vehicle data In addition, the vehicle data can be transmitted via contact line 31 to a workshop 120. Not only is a single contractual workshop of the operator of the motor vehicle designated as workshop 120 but also a corresponding central computer unit of the manufacturer of the vehicle. A monitoring of the state of motor vehicle 40 can be ensured by the flow of appropriately designed vehicle data to workshop 120. Thus, it is possible in accordance with the invention that in addition to the monitoring of motor vehicle 40 by the owner by means of a personal evaluation means 32, 32′, a monitoring of motor vehicle 40 by an external workshop 120 also takes place. Different vehicle data can be transmitted and/or displayed as desired to the owner of motor vehicle 40 and/or of workshop 120.

Monitoring unit 100 in accordance with the invention ensures that all significant information in the vehicle data is monitored. External data device 30 serves as an analysis unit and/or visualizing unit. In order to ensure this, the invention provides that motor vehicle 40 transmits the vehicle data to electronic unit 12 of mobile identification transmitter 10. The vehicle data is transmitted after electronic unit 12 to external data device 30 that carries out an evaluation of the vehicle data Appropriately designed visualizing elements make possible a representation and/or visualization of the vehicle data and/or of the evaluated vehicle data In particular, a visualization can be carried out if the vehicle data exceeds predefined boundary values. The disclosed invention achieves an increase of the safety of motor vehicles 40.

### LIST OF REFERENCE NUMERALS

10 mobile identification transmitter
11 housing
12 electronic unit
13 transmitting and receiving unit
15, 15′, 15″ activation element
20 connection means
30 external data device
31 contact line
32, 32′ evaluation means
33 computer means
40 motor vehicle
41 communication unit
42 communication
43 locking apparatus
44 sensor element
45 connection
100 monitoring system
110 owner's home
120 workshop

1. A mobile identification transmitter in a safety system for a keyless activation of a locking apparatus of a motor vehicle, comprising:
a housing in which an electronic unit with at least one transmitting and receiving unit is arranged,
which electronic unit communicates with a communication unit in the motor vehicle, by means of which an identification check for determining a user authorization can be performed, wherein
vehicle data from the motor vehicle can be transmitted to the electronic unit, and that
the electronic unit comprises a connection means for transmitting the vehicle data to an external data device.

2. The mobile identification transmitter according to claim 1, wherein at least one of the at least one transmitting and receiving unit of the electronic unit and the connection in means have at least one of the following technologies: wireless LAN (IEEE 802.11), FireWire (IEEE 1394), USB (Universal Serial Bus), wireless USB, HDMI (High-Definition Multimedia Interface), IrDA (Infrared Data Association), Bluetooth, Unilink, ATA/ATAPI (Advanced Technology Attachment with Packet Interface), IEEE 488, IEEE 1284, bidirectional radio path, Near Field Communication (NFC) or inductive transmission.

3. The mobile identification transmitter according to claim 1, wherein the mobile identification transmitter comprises a display that uses at least one of the following means: a light-emitting diode (LEDs), an organic light-emitting diode (OLEDs), a liquid crystal display (LCDs), a Surface-Conduction Electron-Emitter display (SED) or a field emission display (FED).

4. The mobile identification transmitter according to claim 3, wherein the vehicle data can be displayed on the display.

5. The mobile identification transmitter according to claim 1, wherein the transmitting and receiving unit secures the communication with the communication unit in the motor vehicle and receives the vehicle data from the motor vehicle, in particular that the connection means is a part of the transmitting and receiving unit or makes use of the transmitting and receiving unit.

6. The mobile identification transmitter according to claim 1, wherein the mobile identification transmitter comprises at least one of a data memory and an energy storage device, in particular a rechargeable energy storage device.

7. The mobile identification transmitter according to claim 1, wherein a computer program can be transmitted to the mobile identification transmitter by the connection means.

8. The mobile identification transmitter according to claim 1, wherein the mobile identification transmitter further comprises a computer element for controlling at least one of the electronic unit and for evaluating the vehicle data.

9. The mobile identification transmitter according to claim 1, wherein the transmitting and receiving unit is a part of at least one of an existing active keyless entry system and of a passive keyless entry system.

10. A monitoring system for a motor vehicle, with a mobile identification transmitter and an external data device, in which the mobile identification transmitter is a part of a safety system for a keyless activation of a locking apparatus of the motor vehicle, the mobile identification transmitter has a housing in which an electronic unit with at least one transmitting and receiving unit is arranged, the electronic unit communicates with a communication unit in the motor vehicle, by means of which an identification check can be carried out for determining a user authorization, vehicle data can be transmitted from the motor vehicle to the electronic unit, and the electronic unit comprises a connection means for transmitting the vehicle data to the external data device.

11. The monitoring system according to claim 10, wherein a data connection to the Internet can be established by the external data device.

12. The monitoring system according to claim 10, wherein the external data device evaluates the vehicle data.

13. The monitoring system according to claim 10, wherein the external data device visualizes at least one of the vehicle data and the evaluated vehicle data.

14. The monitoring system according to claim 10, wherein the external data device is at least one of the following devices: a PC, a PDA, a fax, a notebook or a mobile telephone.

15. The monitoring system according to claim 10, wherein the external data device comprises a receiver for the mobile identification transmitter, in particular, that the external data device comprises a charging device for a rechargeable energy storage device of the mobile identification transmitter.

16. The monitoring system according to claim 10, wherein the external data device comprises an interface for communicating with the connection means of the mobile identification transmitter.

17. The monitoring system according to claim 16, wherein the interface has at least one of the following technologies: wireless LAN (IEEE 802.11), FireWire (IEEE 1394), USB (Universal Serial Bus), wireless USB, HDMI (High-Definition Multimedia Interface), IrDA (Infrared Data Association), Bluetooth, Unilink, ATA/ATAPI (Advanced Technology Attachment with Packet Interface), IEEE 488, IEEE 1284, bidirectional radio path, Near Field Communication (NFC) or inductive transmission.

18. A process for controlling a monitoring system for a motor vehicle, in which the monitoring system comprises a mobile identification transmitter and an external data device, the mobile identification transmitter is part of a safety system for a keyless activation of a locking apparatus of the motor vehicle, which process comprises the steps:
transmission of vehicle data to the electronic unit,
transmission of the vehicle data from the electronic unit to the external data device, and
evaluation of the vehicle data by the external data device.

19. The process according to claim 18, wherein the external data device transmits the vehicle data to the Internet.

20. The process according to claim 18, wherein the mobile identification transmitter is brought into the spatial vicinity of the external data device in order to initiate the transmission.

21. The process according to claim 18, wherein the vehicle data is transmitted to the mobile identification transmitter if the latter is arranged inside the motor vehicle.

22-23. (canceled)

24. A computer program product for carrying out the process according to claim 18, wherein the process steps are integrated in a program stored in the computer program product if the process is carried out on a data processing unit.
